(19) United States
(12) Patent Application Publication
(10) Pub. No.: US 2024/0182039 A1
(43) Pub. Date: Jun. 6, 2024

(54) METHOD AND SYSTEM FOR MONITORING OPERATION OF A VEHICLE

(71) Applicant: GRABTAXI HOLDINGS PTE. LTD., Singapore (SG)

(72) Inventors: Muhammad Rameez CHATNI, Wilmington, DE (US); Jillyn JOHNSON, Wilmington, DE (US); Munirul ABEDIN, Wilmington, DE (US); Haitao BAO, Singapore (SG); Yongchao ZHANG, Wilmington, DE (US); Miaojun LI, Wilmington, DE (US); Laiyi LIN, Singapore (SG)

(21) Appl. No.: 18/556,220

(22) PCT Filed: May 25, 2022
(86) PCT No.: PCT/SG2022/050349

§ 371 Date: Oct. 19, 2023

(30) Foreign Application Priority Data
Jun. 22, 2021 (SG) 10202106805X

(51) Int. Cl. B60W 40/09; B60W 40/109; G01P 15/14

(52) U.S. Cl. CPC B60W 40/09; B60W 40/109; G01P 15/14; B60W 2520/125

(57) ABSTRACT

Aspects of the disclosure relate to a system and a computer implemented method for monitoring operation of a vehicle, including: providing a trip dataset including time data, and accelerometer data obtained from an accelerometer configured to measure acceleration in 3 acceleration axes, wherein the accelerometer may be included in a mobile device being transported by the vehicle during data acquisition of the trip dataset, wherein the trip dataset corresponds to a vehicle trajectory; processing the trip dataset into a uniformly sampled dataset; producing gravitational vector direction data by determining a gravitational vector direction transforming the coordinates from the trip dataset from mobile device coordinates into vehicle coordinates; dividing the uniformly sampled dataset into a plurality of trip segments; for each trip segment of the plurality of trip segments, identifying one or more acceleration events by comparing the acceleration data of the trip segment with pre-determined thresholds; and reducing use of the vehicle.

### TECHNICAL FIELD

An aspect of the disclosure relates to a computer implemented method for monitoring operation of a vehicle. Another aspect of the disclosure relates to a computer system for monitoring operation of a vehicle.

### BACKGROUND

For car hailing, users' feedback on the driver may be used to infer whether a driver is driving well or not, however such feedback is very subjective to the passenger. Speed information can be used to detect overspeeding in a more objective manner. However, more detailed driving behavior, such as aggressive driving, is often not possible to determine only from speed data. Monitoring a vehicle and identifying more detailed vehicle operation may require complex modifications to vehicles to allow for data acquisition and processing, such as installation of dedicated hardware. Thus, there is a need to provide for improved method and system for monitoring vehicle operation.

### SUMMARY

An aspect of the disclosure relates to a computer implemented method for monitoring operation of a vehicle, e.g., of a fleet of vehicles. The method includes providing a trip dataset. The trip dataset includes accelerometer data obtained from an accelerometer configured to measure acceleration in 3 acceleration axes, wherein the accelerometer may be included in a mobile device being transported by the vehicle during data acquisition of the trip dataset, wherein the trip dataset corresponds to a vehicle trajectory. The trip dataset may further include time data. The method includes processing the trip dataset into a uniformly sampled dataset. The method further includes producing gravitational vector direction data by determining a gravitational vector direction. The method further includes transforming the coordinates from mobile device coordinates into vehicle coordinates. The method includes dividing the trip dataset into a plurality of trip segments. The method further includes, for one or more, e.g., for each, trip segment of the plurality of trip segments, identifying one or more acceleration events by comparing the acceleration data of the trip segment with pre-determined thresholds. Dividing may be carried out before processing, and the steps of processing, producing, transforming and identifying may be carried out for two or more, or each, trip segment of the plurality of trip segments. The trip dataset may further include gyroscope data. The method may further include determining, from the gyroscope data, instances of lateral acceleration. The method may further include disregarding the instances of lateral acceleration when producing the gravitational vector direction data, in other words, when producing the gravitational vector direction data, the instances of lateral acceleration may be disregarded.

An aspect of the disclosure relates to a computer system for monitoring operation of a vehicle. The system includes a mobile device for being placed in the vehicle configured to provide a trip dataset including time data, and accelerometer data. The system further includes an accelerometer included in the mobile device and configured to acquire the accelerometer data by measuring acceleration in 3 acceleration axes during transportation of the mobile device by the vehicle. The system includes a computer executable code stored in a memory, configured to cause one or more microprocessors to: process the trip dataset into a uniformly sampled dataset; produce gravitational vector direction data by determining a gravitational vector direction; transform the coordinates from mobile device coordinates into vehicle coordinates; divide the trip dataset into a plurality of trip segments; and for one or more, e.g., for each, trip segment of the plurality of trip segments, identify one or more acceleration events by comparing the acceleration data of the trip segment with pre-determined thresholds. Dividing may be carried out before processing, and the steps of processing, producing, transforming and identifying may be carried out for two or more, or each, trip segment of the plurality of trip segments. The trip dataset may further include gyroscope data. The executable code may be further configured include determining, determine, from the gyroscope data, instances of lateral acceleration. To produce gravitation vector direction data may disregard the instances of lateral acceleration.

An aspect of the disclosure relates to a computer program product and/or a computer readable medium, comprising program instructions, which when executed by one or more processors, cause the one or more processors to perform the method in accordance with various embodiments.

### BRIEF DESCRIPTION OF THE DRAWINGS

The invention will be better understood with reference to the detailed description when considered in conjunction with the non-limiting examples and the accompanying drawings, in which:

FIG. 1A shows an exemplary flowchart of the computer implemented method 100 method in accordance with some embodiments;

FIG. 1B shows an exemplary flowchart of the computer implemented method 100 method in accordance with some embodiments;

FIG. 2 shows an example of axis (x,y,z) in relation to a vehicle (a car is used for illustration purposes);

FIG. 3 shows an example of a vehicle speeding-up;

FIG. 4 shows an example of a vehicle braking (along the vehicle trajectory) which corresponds to a braking event;

FIG. 5 shows an example of a vehicle turning which corresponds to a turning event;

FIG. 6 shows a mobile device 20 in a vehicle 10;

FIG. 7 shows a computer system 200 for monitoring operation of a vehicle;

FIG. 8 shows an example of raw accelerometer data in all 3 coordinates (x, y, z), with acceleration indicated by the vertical axis, over a number of samples;

FIGS. 9A to 9C show the raw gyroscope data in the coordinate system of the mobile phone;

FIGS. 10A to 10C show the gyroscope data in the coordinate system of the vehicle; and

FIG. 11 shows the accelerometer data for a trip segment in the vehicle coordinate system, as acceleration indicated by the vertical axis, over a number of samples shown in the horizontal axis of each plot.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the methods are analogously or systems valid for the other methods or the other systems.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items. As used herein, the term “for” may also include the meaning of “of”. For example a method for monitoring may also include the meaning of method of monitoring.

Various embodiments relate to a computer implemented method for monitoring operation of a vehicle. The method includes providing a trip dataset including accelerometer data. The method includes providing a trip dataset including time data, for example the method may include recording time data points, each corresponding to each of the acceleration datapoint of the accelerometer data. The accelerometer may be configured to measure acceleration in 3 acceleration axes, for example, the accelerometer may be a 3 axes accelerometer (e.g., each axis perpendicular to the other two), or in another example, the accelerometer may include more than 3 axes, wherein the coordinate may be transformed into 3 axes for further processing. The accelerometer may be included in a mobile device being transported by the vehicle during data acquisition of the trip dataset. The trip dataset may correspond to a vehicle trajectory.

The method includes processing the trip dataset into a uniformly sampled dataset. For example, by increasing a data rate of the trip dataset by interpolation, filtering the dataset with a filter, and decimating the dataset into a uniformly sampled dataset.

According to various embodiments, filtering the dataset with a filter may mean applying an anti-aliasing filter with the nyquist frequency as the cutoff frequency. For example, data rate ranges for any one of the accelerometer and gyroscope data may be selected within the range from 10 Hz to 100 Hz.

The method includes producing gravitational vector direction data by determining a gravitational vector direction. For example, determining the gravitational vector direction may include determining the median values in the 3 acceleration axes of portions of the trip data set that correspond to travel in a straight line.

The method includes transforming the coordinates from the trip dataset from mobile device coordinates into vehicle coordinates, e.g., by using the gravitational vector direction as reference.

The method includes dividing the trip dataset into a plurality of trip segments, each of which may be of a pre-determined fixed length. An ending segment may be padded to obtain the fixed length.

The method includes for one or more, e.g., for two or more, or for each, trip segment of the plurality of trip segments, identifying one or more acceleration events by comparing the acceleration data of the trip segment with pre-determined thresholds. If the acceleration data of the trip segment exceeds the pre-determined threshold, an identification result is positive. Dividing may be carried out before processing, and the steps of processing, producing, transforming and identifying may be carried out for two or more, or each, trip segment of the plurality of trip segments. Each trip segment to be processed may be stored in a memory buffer, for example a same memory buffer and processed sequentially.

According to various embodiments, the pre-determined thresholds may include a pre-determined acceleration threshold. The one or more acceleration events may be vehicle speeding up or braking events along the vehicle trajectory and identifying may include comparing an acceleration along an acceleration axis that follows the vehicle trajectory against the pre-determined acceleration threshold. For example, the pre-determined acceleration threshold may include on or both of a speeding up threshold for identifying speeding-up events, and a braking threshold for identifying breaking events. In an alternative, the pre-determined acceleration threshold may be a single threshold and speed-up or acceleration may be distinguished by the sign of the acceleration.

According to various embodiments, the pre-determined thresholds may include a pre-determined lateral acceleration threshold. The one or more acceleration events may be vehicle turning events, for example, in a curve, a change of lane, a lane correction, or a U-turn). The vehicle turning events may be lateral movements in the vehicle trajectory and identifying may include comparing an acceleration along an acceleration axis, which may be orthogonal to the vehicle trajectory and orthogonal to the gravitational vector direction, against the pre-determined lateral acceleration threshold. Before the identifying, data of the dataset may be filtered to remove instances of lateral acceleration, such as from a turning vehicle, by using gyroscope data, thus acceleration data during lateral acceleration events may be disregarded.

According to various embodiments, the computer implemented method may include reducing usage of the vehicle for transport tasks if the number of identified one or more acceleration events exceeds a safety condition. In some embodiments, the safety condition is a pre-defined safety limit, and the method further includes determining that the number of identified one or more acceleration events exceeds the pre-defined safety limit.

According to some embodiments, the computer implemented method may further include generating a report including the one or more acceleration events. The one or more acceleration events may include respective time and/or location data. The method may further include generating a safety score based on the report. The safety score may be associated to and determined for a driver. According to some embodiments, the number of identified one or more acceleration events exceed the safety condition when the safety score exceeds a predefined safety limit.

According to various embodiments, the computer implemented method may further include sending the safety score to a service allocation server, e.g., for prioritizing allocation of drivers to orders based on the safety score, e.g., for allocating less services to a driver with a lower safety score. The system and method disclosed herein may monitor the operation of a vehicle and may monitor the operation of vehicles in a fleet of vehicles, for example the system may monitor the operation of each vehicle in the fleet.

Various embodiments relate to a computer system for monitoring operation of a vehicle. The system includes a mobile device for being placed in the vehicle. The trip data set may further include accelerometer data. The mobile device is configured to provide a trip dataset including time data, for example, including time data points, each corresponding to each of the acceleration datapoint of the accelerometer data. The trip dataset may correspond to a vehicle trajectory.

The system may include an accelerometer included in the mobile device and configured to acquire the accelerometer data by measuring acceleration in 3 acceleration axes during transportation of the mobile device by the vehicle. The accelerometer may be configured to measure acceleration in 3 acceleration axes, for example, the accelerometer may be a 3 axes accelerometer (e.g., each axis perpendicular to the other two), or in another example, the accelerometer may include more than 3 axes, wherein the coordinate may be transformed into 3 axes for further processing.

The system may include a computer executable code stored in a memory, configured to cause one or more microprocessors to carry out processing steps. For example, the memory and the one or more microprocessors may be included in the mobile device, or in an external server. The processing steps may include to process the trip dataset into a uniformly sampled dataset and the computer executable code may be configured accordingly. To process the trip dataset may include to increase a data rate of the trip dataset by interpolation, filter the dataset with a filter, and decimate the dataset into a uniformly sampled dataset.

The processing steps may include to produce gravitational vector direction data by identifying a gravitational vector direction and the computer executable code may be configured accordingly. Identifying may include determining the median values in the 3 acceleration axes of portions of the trip data set that correspond to travel in a straight line. The method may further include disregarding the instances of lateral acceleration when producing the gravitational vector direction data, in other words, when producing the gravitational vector direction data, the instances of lateral acceleration may be disregarded.

The processing steps may include to transform the coordinates from the trip dataset from mobile device coordinates into vehicle coordinates and the computer executable code may be configured accordingly. The coordinate transformation may be based on the gravitational vector direction which may be used as reference.

The processing steps may include to divide the uniformly sampled dataset into a plurality of trip segments and the computer executable code may be configured accordingly. Each of the segments may be of a pre-determined fixed length. An ending segment may be padded to obtain the fixed length.

The processing steps may include to, for one or more, for two or more, or for each, trip segment of the plurality of trip segments, identify one or more acceleration events by comparing the acceleration data of the trip segment with pre-determined thresholds, and the computer executable code may be configured accordingly.

According to various embodiments, the pre-determined thresholds may include a pre-determined acceleration threshold. The one or more acceleration events may be vehicle speeding up or braking events along the vehicle trajectory and identifying may include comparing an acceleration along an acceleration axis that follows the vehicle trajectory against the pre-determined acceleration threshold. For example, the pre-determined acceleration threshold may include on or both of a speeding up threshold for identifying speeding-up events, and a braking threshold for identifying breaking events. In an alternative, the pre-determined acceleration threshold may be a single threshold and speed-up or acceleration may be distinguished by the sign of the acceleration.

According to various embodiments, the pre-determined thresholds may include a pre-determined lateral acceleration threshold. The one or more acceleration events may be vehicle turning events, for example, in a curve, a change of lane, a lane correction, or a U-turn). The vehicle turning events may be lateral movements in the vehicle trajectory and identifying may include comparing an acceleration along an acceleration axis, which may be orthogonal to the vehicle trajectory and orthogonal to the gravitational vector direction, against the pre-determined lateral acceleration threshold.

According to various embodiments, the computer executable code may be further configured to cause the one or more microprocessors to reduce usage of the vehicle for transport tasks if the number of identified one or more acceleration events exceeds a safety condition. In some embodiments, the safety condition is a pre-defined safety limit, and the computer executable code may be further configured to cause the one or more microprocessors determine that the number of identified one or more acceleration events exceeds the pre-defined safety limit.

According to various embodiments, the computer executable code may be further configured to cause the one or more microprocessors to generate a report including the one or more acceleration events and to generate a safety score based on the report. The report may include time and/or location data corresponding to the acceleration events. According to some embodiments, the number of identified one or more acceleration events exceed the safety condition when the safety score exceeds a predefined safety limit.

According to various embodiments, the computer executable code may be further configured to cause the one or more microprocessors to send the safety score to a service allocation server, e.g., for prioritizing allocation of drivers to orders based on the safety score, e.g., for allocating less services to a driver with a lower safety score.

According to various embodiments, the mobile device may be configured to send the trip data to a processing server, wherein the processing server includes the memory and one, some, or all of the one or more microprocessors.

As used herein and in accordance with various embodiments, the mobile device may be a handheld digital device, a smartphone, a tablet.

As used herein and in accordance with various embodiments, interpolating may mean applying an interpolation filter.

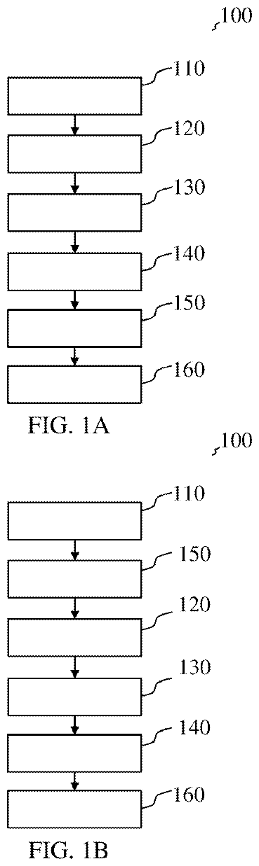

FIG. 1A shows an exemplary flowchart of the computer implemented method 100 method in accordance with some embodiments. While steps of the flowchart are shown in a certain sequence, the sequence may be altered and further method steps may be inserted as needed. The computer implemented method 100 for monitoring operation of a vehicle includes a step 110 of providing a trip dataset, e.g., including time data and/or location stamp. The method 100 may further include a step 120 of processing 120 the trip dataset into a uniformly sampled dataset, e.g., increasing a data rate of the trip dataset by interpolation (or another up-sampling method), filtering the dataset with a filter, and decimating the dataset into a uniformly sampled dataset. The method 100 may further include a step 130 of producing gravitational vector direction data by identifying a gravitational vector direction. The method 100 may further include a step 140 of transforming the coordinates from the trip dataset from mobile device coordinates into vehicle coordinates, e.g., by using the previously calculated gravitational vector direction as reference. The method 100 may further include a step 150 of dividing the uniformly sampled dataset into a plurality of trip segments. The method 100 may further include a step 160 including, for one or more, two or more, or for each, trip segment of the plurality of trip segments, identifying one or more acceleration events by comparing the acceleration data of the trip segment with pre-determined thresholds. The method may further include disregarding the instances of lateral acceleration when producing the gravitational vector direction data (e.g., before step 130), in other words, when producing the gravitational vector direction data, the instances of lateral acceleration may be disregarded.

FIG. 1B shows an exemplary flowchart of the computer implemented method 100 method in accordance with some embodiments. While steps of the flowchart are shown in a certain sequence, the sequence may be altered and further method steps may be inserted as needed. The computer implemented method 100 for monitoring operation of a vehicle includes a step 110 of providing a trip dataset, e.g., including time data and/or location stamp. The method 100 may further include a step 150 of dividing the uniformly sampled dataset into a plurality of trip segments. The method 100 may further include a step 120 of processing 120 the trip dataset (for one or more, e.g., two or more, e.g. each of the plurality of trip segments) into a uniformly sampled dataset, e.g., increasing a data rate of the trip dataset by interpolation (or another up-sampling method), filtering the dataset with a filter, and decimating the trip dataset into a uniformly sampled dataset. The method 100 may further include a step 130 of producing gravitational vector direction data by identifying a gravitational vector direction, for one or more, e.g., two or more, e.g. each of the plurality of trip segments. The method 100 may further include a step 140 of transforming the coordinates from the trip dataset from mobile device coordinates into vehicle coordinates (for one or more, e.g., two or more, e.g. each of the plurality of trip segments), e.g., by using the previously calculated gravitational vector direction as reference. The method 100 may further include a step 160 including, for one or more, two or more, or for each, trip segment of the plurality of trip segments, identifying one or more acceleration events by comparing the acceleration data of the trip segment with pre-determined thresholds. The method may further include disregarding the instances of lateral acceleration when producing the gravitational vector direction data (e.g., before step 130), in other words, when producing the gravitational vector direction data, the instances of lateral acceleration may be disregarded.

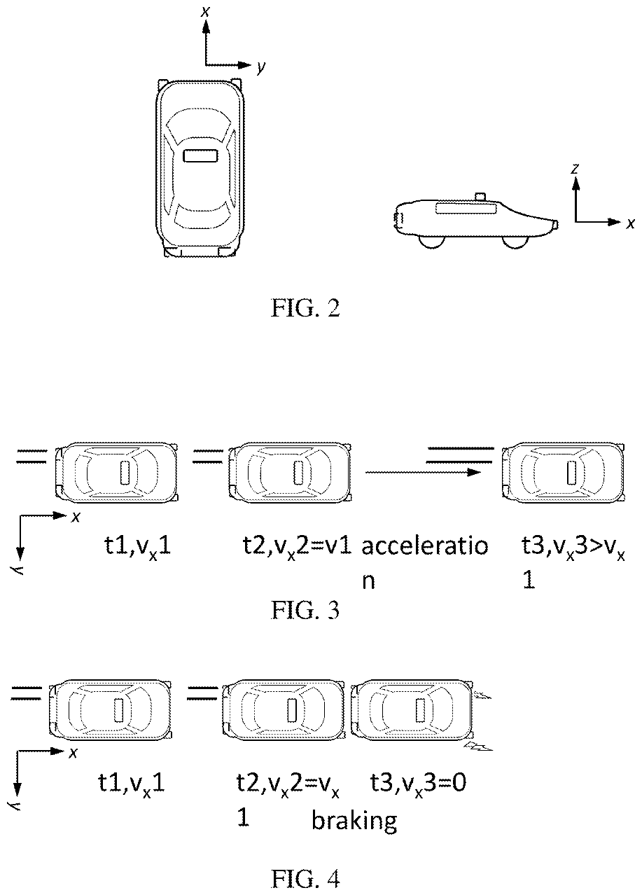

FIG. 2 shows an example of axis (x,y,z) in relation to a vehicle (a car is used for illustration purposes). Axis x is the acceleration axis that follows the vehicle trajectory (when straight). Axis y is orthogonal to the vehicle trajectory and orthogonal to the gravitational vector direction (axis z). The axis shown in FIG. 2 are examples of the vehicle coordinates. An origin of the coordinate system may be within the vehicle boundaries or exterior but in fixed relation to the vehicle.

FIG. 3 shows an example of a vehicle speeding-up, i.e., with positive acceleration along the vehicle trajectory (x) which corresponds to a speeding up event. As illustrated in FIG. 3, at a time t1, the vehicle has a first speed (non-zero) vₓ1, at a time t2, the vehicles speed vₓ2 is identical to vₓ1 indicating that there has not been any net acceleration between times t1 and t2, which may indicate that the vehicle had uniform velocity between these two time points. At time t3, a speed vₓ3 is measured which is higher than vₓ1 and vₓ2 indicating that there has been an acceleration between times t2 and t3. While FIG. 3 is presented for illustration purposes, the accelerometer data provides acceleration data corresponding to a time point (e.g., same instant). If any data point (e.g., aₓᵢ at a time tᵢ) of the acceleration (e.g., after the transformation of the trip dataset into the uniformly sampled dataset) is greater than the pre-determined acceleration threshold (aₓᵢ>aₓₜₕ) then this may be identified as a speeding up event. The speeding up event may have an associated time (tᵢ) and/or an associated geographical location, e.g., in the format of [Latitude, Longitude].

FIG. 4 shows an example of a vehicle braking (along the vehicle trajectory) which corresponds to a braking event. As illustrated in FIG. 4, at a time t1, the vehicle has a first (non-zero) speed vₓ1, at a time t2, the vehicles speed vₓ2 is identical to vₓ1 indicating that there has not been any net acceleration between times t1 and t2, which may indicate that the vehicle had uniform velocity between these two time points. At time t3, a speed vₓ3 is measured which is zero indicating that there has been a negative acceleration (i.e., a brake) between times t2 and t3. While FIG. 4 is presented for illustration purposes, the accelerometer data provides acceleration data corresponding to a time point (e.g., same instant). If any data point (e.g., aₓᵢ at a time tᵢ) of the acceleration (e.g., after the transformation of the trip dataset into the uniformly sampled dataset) is greater than the pre-determined braking threshold (aₓᵢ>brakₓₜₕ) then this may be identified as a braking event. The comparison may include sign (positive and negative) or be performed in modulus, for example, the braking threshold may be provided without sign (as a modulus) and provided that aₓᵢ<0, the comparison may include |aₓᵢ|>brakₓₜₕ, or alternatively aₓᵢ>brakₓₜₕ wherein the braking threshold is signed (negative). The braking event may have an associated time (tᵢ) and/or an associated geographical location, e.g., in the format of [Latitude, Longitude].

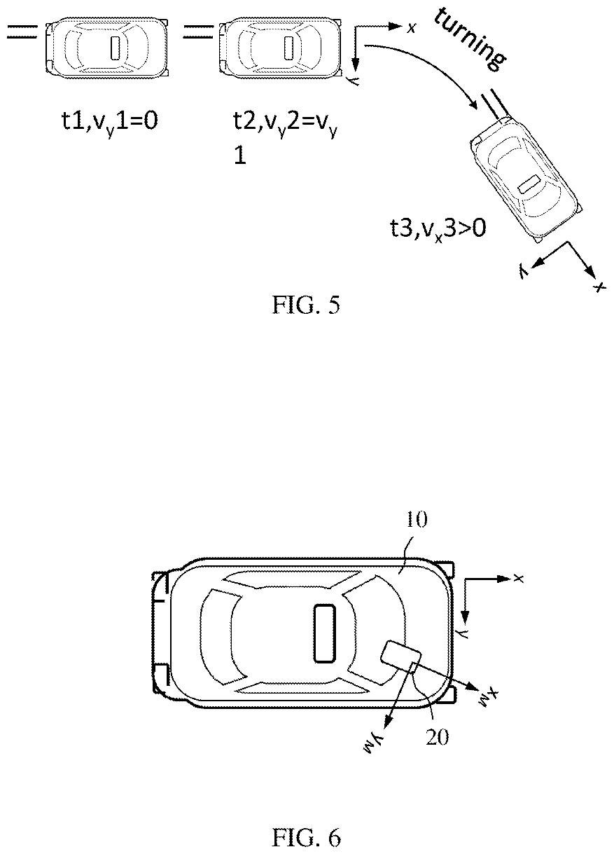

FIG. 5 shows an example of a vehicle turning which corresponds to a turning event. Other turning events may be, for example, turning a curve, a changing a lane, a lane correction, a U-turn. As illustrated in FIG. 5, at a time t1, the vehicle has a substantial null lateral speed v_{y}1, at a time t2, the vehicles speed v_{y}2 is identical to v_{y}1 which may indicate that the vehicle has been traveling straight between these two time points. At time t3, a lateral speed v_{y}3 is measured which is different from null indicating that the vehicle is turning (e.g., in a curve). FIG. 5 is presented for illustration purposes, and, as described above, the accelerometer data provides acceleration data corresponding to a time point (e.g., same instant). If any data point (e.g., a_{yi} at a time tᵢ) of the lateral acceleration (e.g., after the transformation of the trip dataset into the uniformly sampled dataset) is greater than the pre-determined lateral acceleration threshold (aₓᵢ>turn_{yth}) then this may be identified as a turning event. The comparison may, e.g., be in modulus, or may include the sign to indicate whether the lateral acceleration is left or right. The turning event may have an associated time (tᵢ) and/or an associated geographical location, e.g., in the format of [Latitude, Longitude].

FIG. 6 shows a mobile device 20 in a vehicle 10. The mobile device has its coordinate system, e.g. (x_{M}, y_{M}, z_{M}) and the vehicle has its own coordinate system, e.g., (x, y, z). In some embodiments, the mobile device 20 may include the accelerometer and may be configured to carry out the transformation 140 of the trip dataset from the coordinates of the mobile device into the vehicle coordinates. The coordinate systems shown are for illustration only, and different coordinate systems may be employed as well.

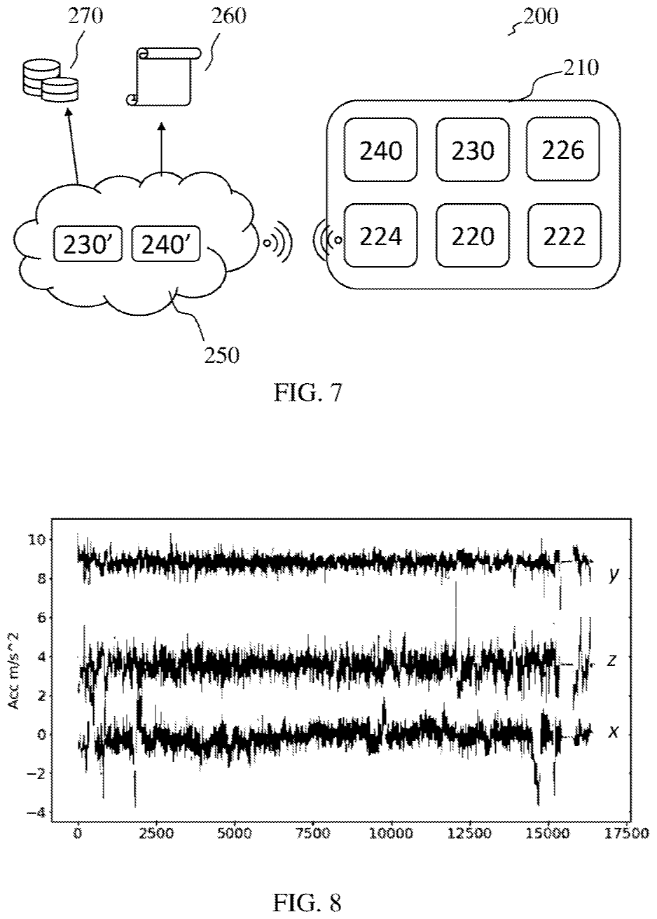

FIG. 7 shows a computer system 200 for monitoring operation of a vehicle. The system 200 includes a mobile device 210 (e.g., a smartphone) for being placed in the vehicle and being configured to provide a trip dataset including time data, and accelerometer data. The mobile device 210 includes an accelerometer 220, being configured to acquire the accelerometer data. The system may include a computer executable code stored in a memory, configured to cause one or more microprocessors to carry out processing steps as described herein in accordance with various embodiments.

The mobile device 210 may further include one or more of: a display 226, a gyroscope 222, and a communication interface 224.

The processing steps may be carried out by the mobile device 210 or by a processing server 250. In some embodiments, some of the processing steps are carried out by the mobile device 210 and other some of the processing steps are carried out by the processing server 250.

For example, the computer executable code may be stored in a memory 230 of the mobile device 210 and may be configured to cause the microprocessor 240 (of the mobile device 210) to carry out the processing steps. The computer executable code may be further configured to cause the microprocessor 240 to generate a report 260 including the one or more acceleration events (and optionally, the respective time and/or location data) and to generate a safety score based on the report 260. The computer executable code may be further configured to cause the microprocessor 240 to send the safety score to a service allocation server 270, for example, via the communication interface 224.

In another example, the mobile device 210 may be configured to send the trip data to the processing server 250. The server may include a memory 230′ and a microprocessor 240′. The computer executable code may be stored in a memory 230′ of the processing server 250. The memory buffer may be an allocated portion of the server memory, e.g., of the memory 230′. The computer executable code may be configured to cause the microprocessor 240′ (of the processing server 250) to receive the trip data from the mobile device 210 (e.g., via a server side communication interface, not shown) and to carry out the processing steps. The computer executable code may be further configured to cause the microprocessor 240′ to generate a report 260 including the one or more acceleration events (and optionally, the respective time and/or location data) and to generate a safety score based on the report 260. The computer executable code may be further configured to cause the microprocessor 240′ to send the safety score to a service allocation server 270, for example, via the server side communication interface.

An example will be explained in connection with FIGS. 8 to 11.

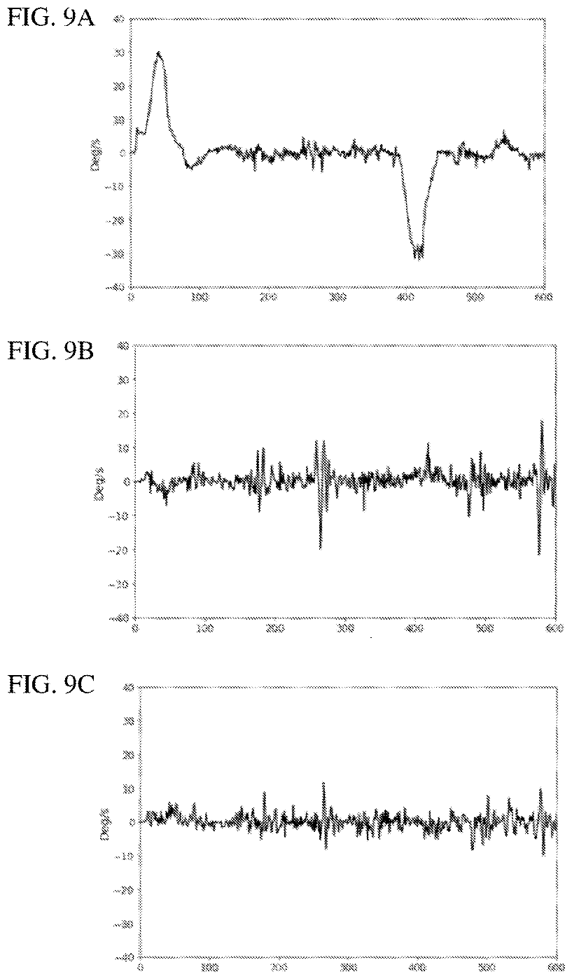

In one example, raw sensor data is collected from an accelerometer of a mobile device as trip dataset and uploaded to a server, also named as backend herein. Data pre-processing may be carried out by the mobile phone before uploading the trip dataset to the backend, for example to ensure time alignment of the data. FIG. 8 shows an example of raw accelerometer data in all 3 coordinates (x, y, z), with acceleration indicated by the vertical axis, over a number of samples. The number of samples may correspond to time, and/or time information may be included as timestamp on each datapoint. For example, FIGS. 9, 10, and 11 show plots of data over a duration of 1 minute, for clear illustration of peaks. According to various embodiments, a trip segment may have a duration selected from 30 seconds to 10 minutes, for example, from 1 minute to 2 minutes, such as 1 minute.

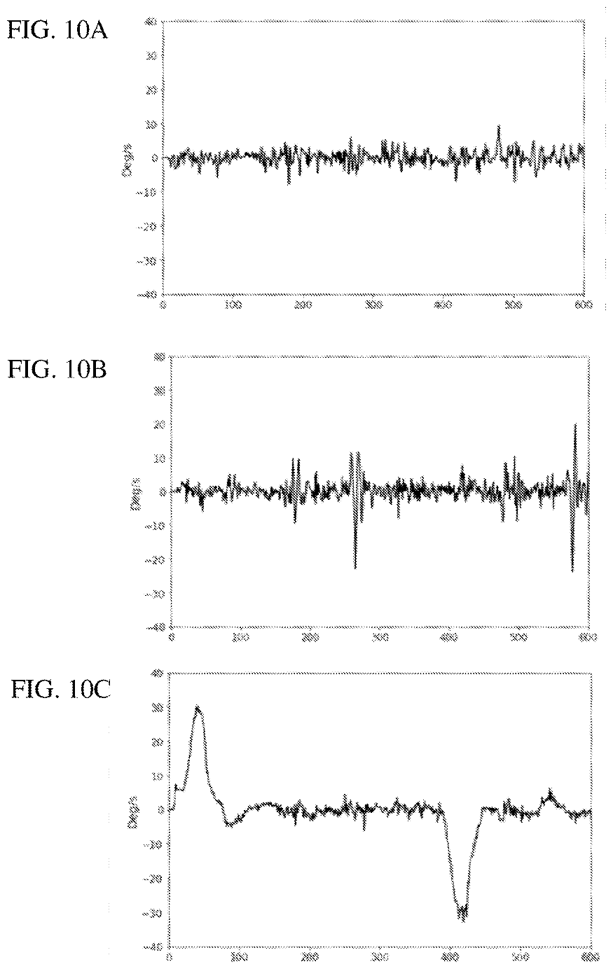

Further in the example, the trip dataset is broken down into a plurality of trip segments (also named as time segments), and the trip dataset (e.g., the accelerometer and gyroscope data) is analyzed within each segment. The orientation of the mobile device is estimated. And the trip dataset is aligned, by coordinate transformation, to the coordinate system of the vehicle. For example, FIGS. 9A to 9C show the raw gyroscope data in the coordinate system of the mobile phone. Vertical axes represent an angle per time (e.g., Deg/s) and the horizontal axes represent the number of samples. The x_{M} direction is shown in FIG. 9A, y direction is shown in FIG. 9B, and z_{M} direction is shown in FIG. 9C. FIGS. 10A to 10C shows the gyroscope data in the coordinate system of the vehicle. Vertical axes represent an angle per time (e.g., Deg/s) and the horizontal axes represent the number of samples. The x direction is shown in FIG. 10A, y direction is shown in FIG. 10B, and z direction is shown in FIG. 10C.

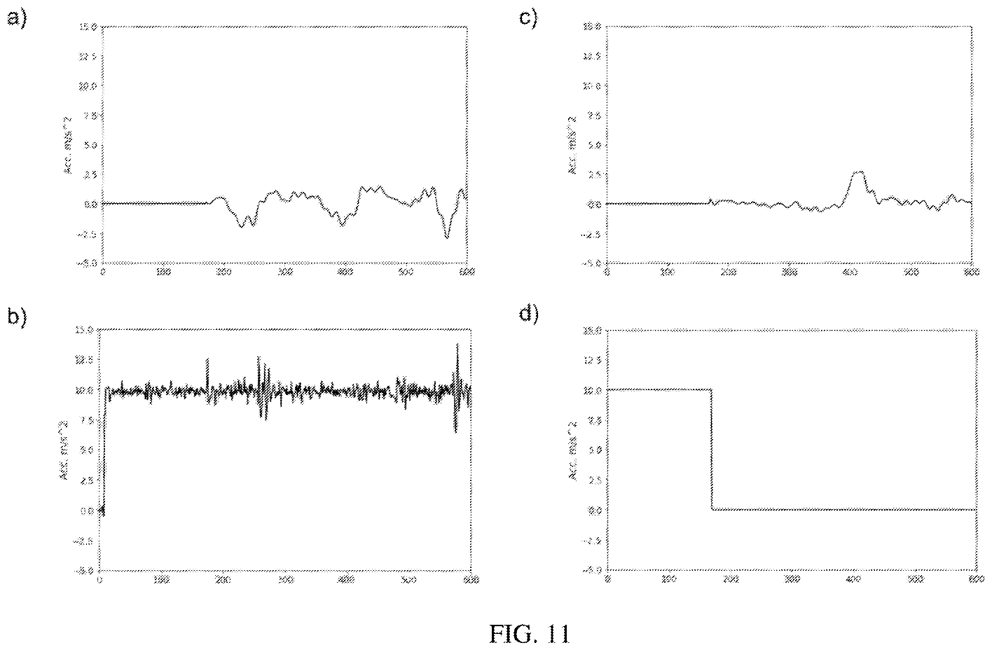

FIG. 11 shows the accelerometer data for a trip segment in the vehicle coordinate system, as acceleration indicated by the vertical axis, over a number of samples shown in the horizontal axis of each plot. Plot a) in FIG. 11 shows the vehicle's acceleration profile in forward direction (x), wherein positive values refer to speeding up (forward acceleration) and negative values refer to braking, for illustration purposes. A harsh braking event near sample 550 (a large negative spike) can be observed. Plot b) in FIG. 11 shows the vehicle's vertical acceleration (z), which can be seen to be, on average, earth's gravitational constant. The vertical acceleration is nearly equal to gravitational acceleration on average. Plot c) in FIG. 11 shows the vehicle's lateral (or sideways) acceleration (y). Plot d) in FIG. 11 shows an exemplary mask in the form of a window used to remove undesired data, and to keep the data within the window(s), for example, the mask of plot d) may be used to prohibit the detection of speeding up, braking, or vehicle turning events from undesirable acceleration data recorded such as non-vehicular accelerations from mobile device (e.g. phone) motions. Undesirable acceleration data may be marked out as a window in the mask shown in FIG. 11 d). Sections of the acceleration data corresponding to a pre-defined void-data value (e.g. 10) on the mask is denoted as undesirable accelerations. At the end of trip processing, a trip report is created which may be saved for ranking drivers in their respective geographic areas.

According to various embodiments, the gyroscope data may be used to increase precision of the detection of vehicle turning events, optionally alone or in combination with lateral acceleration data.

According to some embodiments, the gyroscope data may be used to detect other rotations in the vehicle, for example, leaning of drivers on a motorbike.

It is shown herein that it is possible to utilize sensors such as accelerometer, gyroscope and GPS that are commonly present on mobile devices for monitoring a vehicle operation. Mobile devices are not in fixed orientation to the vehicle, and it is assumed herein that they are not necessarily fixed over the duration of a trip. Therefore, utilizing the strengths of each of these sensors along with signal processing algorithms, it is able to infer the orientation of the mobile device. With the orientation of the mobile device, the orientation of the mobile device may be adjusted which enables monitoring of vehicle operation, including parameters such as harsh acceleration, harsh brake and harsh turning events as described herein in accordance with various embodiments.

Monitoring of vehicle operation may be used to identify potential high crash risk drivers, and drivers who may not provide a positive rider experience. This helps enhancing the safety of an e-hailing platform, e.g., by providing lower allocation priority for less safe drivers.

Aspects of the present disclosure allow monitoring vehicle(s) operation on a large dataset and even in near real time, for example, with daily or hourly updates for all active drivers in a large ride-hailing network, e.g. a fleet which may comprise hundreds of vehicles.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A computer implemented method for monitoring operation of a vehicle, comprising:
providing a trip dataset comprising time data, and accelerometer data obtained from an accelerometer configured to measure acceleration in 3 acceleration axes, wherein the accelerometer is comprised in a mobile device being transported by the vehicle during data acquisition of the trip dataset, wherein the trip dataset corresponds to a vehicle trajectory;
dividing the trip dataset into a plurality of trip segments; and
for each trip segment of the plurality of trip segments, by any of one or more microprocessors:
processing the trip dataset into a uniformly sampled dataset;
producing gravitational vector direction data by determining a gravitational vector direction;
transforming the coordinates from mobile device coordinates into vehicle coordinates;
identifying one or more acceleration events by comparing the acceleration data of the trip segment with pre-determined thresholds; and
reducing usage of the vehicle for transport tasks if the number of identified one or more acceleration events exceeds a safety condition.

2. The computer implemented method of claim 1, wherein the pre-determined thresholds comprise a pre-determined acceleration threshold;
wherein the one or more acceleration events are vehicle speeding up or braking events along the vehicle trajectory and identifying comprises comparing an acceleration along an acceleration axis that follows the vehicle trajectory against the pre-determined acceleration threshold.

3. The computer implemented method of claim 1, wherein the pre determined thresholds comprise a pre-determined lateral acceleration threshold; wherein the one or more acceleration events are vehicle turning events which are lateral movements in the vehicle trajectory and identifying comprises comparing an acceleration along an acceleration axis, which is orthogonal to the vehicle trajectory and orthogonal to the gravitational vector direction, against the pre-determined lateral acceleration threshold.

4. The computer implemented method of claim 3,
wherein the safety condition is a predefined safety limit, and the method further comprises: determining that the number of identified one or more acceleration events exceeds the predefined safety limit.

5. The computer implemented method claim 1, further comprising generating a report including the one or more acceleration events and generating a safety score based on the report.

6. The computer implemented method of claim 5, further comprising sending the safety score to a service allocation server.

7. The computer implemented method of claim 6,
wherein the number of identified one or more acceleration events exceed the safety condition when the safety score exceeds a predefined safety limit.

8. The computer implemented method of claim 1, wherein the trip dataset further comprises gyroscope data; and the method further comprises:
determining, from the gyroscope data, instances of lateral acceleration.

9. The computer implemented method of claim 8, further comprising:
disregarding the instances of lateral acceleration when producing the gravitational vector direction data.

10. A computer system for monitoring operation of a vehicle, comprising:
a mobile device for being placed in the vehicle configured to provide a trip dataset comprising time data, and accelerometer data, wherein the trip dataset corresponds to a vehicle trajectory;
an accelerometer comprised in the mobile device and configured to acquire the accelerometer data by measuring acceleration in 3 acceleration axes during transportation of the mobile device by the vehicle;
a computer executable code stored in a memory, configured to cause one or more microprocessors to:
process the trip dataset into a uniformly sampled dataset;
divide the uniformly sampled dataset into a plurality of trip segments; and
for each trip segment of the plurality of trip segments:
produce gravitational vector direction data by determining a gravitational vector direction;
transform the coordinates from mobile device coordinates into vehicle coordinates;
identify one or more acceleration events by comparing the acceleration data of the trip segment with pre-determined thresholds; and
reduce usage of the vehicle for transport tasks if the number of identified one or more acceleration events exceeds a safety condition.

11. The computer system of claim 10, wherein the pre-determined thresholds comprise a pre-determined acceleration threshold;
wherein the one or more acceleration events are vehicle speeding up or braking events along the vehicle trajectory and to identify comprises to compare an acceleration along an acceleration axis that follows the vehicle trajectory against the pre-determined acceleration threshold.

12. The computer system of claim 10, wherein the pre-determined thresholds comprises a pre-determined lateral acceleration threshold;
wherein the one or more acceleration events are vehicle turning events which are lateral movements in the vehicle trajectory and to identify comprises to compare an acceleration along an acceleration axis, which is orthogonal to the vehicle trajectory and orthogonal to the gravitational vector direction, against the pre-determined lateral acceleration threshold.

13. The computer system of claim 10, wherein the computer executable code is further configured to cause the one or more microprocessors to generate a report including the one or more acceleration events and to generate a safety score based on the report.

14. The computer system of claim 13, wherein the computer executable code is further configured to cause the one or more microprocessors (240, 240′) to send the safety score to a service allocation server.

15. The computer system of claim 10, wherein the mobile device is configured to send the trip data to a processing server, wherein the processing server comprises the memory and the one or more microprocessors.

16. The computer system of claim 10, wherein the trip dataset further comprises gyroscope data; and the executable code is further configured to:
determine, from the gyroscope data, instances of lateral acceleration.

17. The computer system of claim 16, wherein to produce gravitation vector direction data disregards the instances of lateral acceleration.

18. A computer program product comprising program instructions, which when executed by one or more processors, cause the one or more processors to perform the method of claim 1.

19. A computer readable medium comprising program instructions, which when executed by one or more processors, cause the one or more processors to perform the method of claim 1.
